(19) United States
(12) Patent Application Publication
(10) Pub. No.: US 2010/0087763 A1
(43) Pub. Date: Apr. 8, 2010

(54) Hand-held cradle for ball massage

(76) Inventor: Heather Hane-Karr, Newbury Park, CA (US)

Correspondence Address: Heather Hane-Karr, 651 Valley Oak Lane, Newbury Park, CA, 91320, US

(21) Appl. No.: 12/587,134

(22) Filed: Oct. 2, 2009

Related U.S. Application Data
(60) Provisional application No. 61/195,021, filed on Oct. 2, 2008.

(51) Int. Cl. A61H 7/00

(52) U.S. Cl. 601/137

(57) ABSTRACT

A massage implement is provided that incorporates the use of commonly available golf balls, or other objects of similar dimensions and properties. The massage implement comprises a rigid or semi-rigid housing to hold a golf ball, a cavity to allow such golf ball to move freely within the implement, a comfortable and ergonomically balanced shape, finger impressions for greater control and grip, and other built-in utilities essential to a proper massage and other affiliated uses.

Massage therapy is beneficial to overall health and wellness. The preferably shaped golf ball is uniquely suited to massage therapy because of its size, shape, weight, and common availability. These dimensions and properties allow the user to properly treat a person throughout the course of rehabilitation after an injury, and for general health maintenance and wellness.

Not only does the massage implement provide a beneficial service to the user, it is also customizable for promotional or marketing purposes by standard imprinting techniques.

### CROSS-REFERENCE TO RELATED APPLICATIONS

This PCT claims the benefit of co-pending United States Non-Provisional Application Ser. No. 61/195,021, filed on Oct. 2, 2008, which is incorporated herein.

### BACKGROUND OF THE INVENTION

1. Technical Field

The present invention relates generally to a massage therapy implement, and more particularly, to a massage therapy device that comprises an ergonomically balanced housing made of a rigid, or semi-rigid, material for housing a ball to be used in manipulation of the human body in a therapeutic fashion.

2. Background Art

Massage therapy benefits human health and wellness. By physical manipulation of the muscular system, a massage therapist can loosen a tight, “knotted,” or contracted muscle, oxygenate the muscle, and increase blood flow to the muscle to aid in healing. This is often achieved by applying pressure to specific areas of the muscle and surrounding tissues in a rubbing or “kneading” fashion.

It is well known that massage therapy is beneficial, if not crucial, to the general maintenance of health and wellness, as well as, rehabilitation after an injury. Further, it is often the case that muscular problems can cause, or are caused by, skeletal and other physical ailments which substantially impair the overall health of an individual. Yet developing a proper device to achieve such ends that is economical, ergonomic, compact, effective, versatile, and readily available continues to be a challenge.

Due to the popularity of massage therapy and the difficulty of achieving “deep tissue” manipulation of a muscle, numerous types of massage implements have been developed. However, the conventionally available massage devices are all deficient in one or more areas.

Many massage devices are heavy, bulky, or cumbersome. This often means an unruly or awkward experience for the user and the object of the massage. Additionally, such devices can cause injury to the user due to rigorous and repetitive motion. Further, the object of the massage must often contort his or herself in strange positions in order to accommodate such devices. Finally, such devices can be difficult to transport or store.

Many massage devices are inconvenient and expensive because they contain motors, complex electronics, moving pieces, and are comprised of several parts. Such devices require the use of electricity or batteries which may be unavailable to the user. Often, a failure in such devices renders the device utterly useless for its intended application. Additionally, the composition of electronic parts renders such devices financially unavailable to many users.

Also, the particular shapes of many massage devices are not ergonomical or versatile. Such devices can cause injury to the user as well as the object of the massage. The user is often required to hold the device in an uncomfortable and unnatural position for extended periods of time. Further, the larger devices decrease or eliminate the user's tactile contact with the object of the massage. Application of the correct pressure is critical in an effective massage and any loss of tactile sensitivity, or control of the device, by the user can cause injury to the object of the massage. Additionally, many devices are often too large to reach critical and targeted areas, such as under the scapula, around the trapezius, or any “trigger points”. Conversely, many devices are too small and can cause pain to the object of the massage if too much pressure is applied. Finally, many devices are constructed particularly for only a right-handed or left-handed person which requires a user with the opposing dexterity to purchase a separate device.

Many massage devices are either incapable of being heated, or it is simply impractical to do so. Some such devices may have an internal heating mechanism, but these devices often suffer from the aforementioned expense and are ill-suited or non-ergonomic shape or size. Other such devices, which can be heated by other means, are often deficient because, once the device cools, the user must cease using the device until it is reheated. Still, other such devices cannot safely be heated because of the particular materials comprising the device.

Also, many massage devices are either incapable of being cleaned or sanitized, or it is unsafe or impractical to do so. The use of oils and lotions is common in massage therapy, but they often leave an undesired residue on the massage implement. Many electronic devices cannot be properly cleaned without disassembling protective shields or components in an unsafe manner. Further, the use of cleaning solutions can cause critical electronics to “short-out” or malfunction. Some devices use materials which are porous, such as wood, which can trap bacteria and other unsanitary agents. Such materials are exceptionally difficult to properly clean or sanitize. Some devices are often difficult to clean because of their particular design. For instance, a rolling ball, that is permanently encased in a housing, cannot be separated and cleaned effectively.

Finally, many massage devices do not serve any ulterior purpose other than its use as a massage implement. Many devices have little to no cross-marketing appeal with other industries. Many other devices lack any promotional value because they are incapable of being customized or branded in a cost effective manner. Lastly, few devices provide any dual purpose functionality.

Thus, though varied massage devices have been proposed, all suffer from one or more of the above disadvantages.

Accordingly, there is an established need for a compact, convenient, inexpensive, ergonomic, sanitary, and multi-purpose massage implement that can be properly and safely heated for an effective and continuous massage.

### DISCLOSURE OF THE INVENTION

The present invention is directed to an inexpensive, convenient, sanitary, and versatile massage implement that is simply and uniquely constructed so as to accept a commonly available golf ball, or other similarly situated objects. The massage implement comprises a hand-friendly and ergonomically shaped design made of a rigid or semi-rigid material, with strategically placed contours for the user's fingers and thumb, and contains a cavity to accept a golf ball to be used for massage purposes.

A golf ball is particular suited to massage therapy purposes because of its size, shape, weight, and commonplace accessibility or availability. The particular dimensions of the golf ball, and the massage implement itself, allow the user to maintain the critical tactile contact with the object of the massage.

The massage implement can be constructed of a variety of materials based upon the particular embodiment or application (such as, for example, plastic, silicone, Pyrex®, or stone). These materials and manufacturing methods lend themselves to serving a multitude of other functions (such as, for example, a golf ball liner or a golf tee holder).

An additional object of the present invention is to provide a massage implement that can utilize an ideally shaped golf ball or other similarly situated object with similar proportions.

An additional object of the present invention is to provide a massage implement that is quite inexpensive.

An additional object of the present invention is to provide a massage implement that is simply constructed and manufactured.

An additional object of the present invention is to provide a massage implement that utilizes commonly available and inexpensive components.

An additional object of the present invention is to provide a massage implement that does not require multiple, complex, electrical, or mechanical components.

An additional object of the present invention is to provide a massage implement that is compact, convenient, as well as easy to transport and store.

An additional object of the present invention is to provide a massage implement that is ergonomically suited to the user's hand.

An additional object of the present invention is to provide a massage implement that can be used by either the right or left hand.

An additional object of the present invention is to provide a massage implement that is safe to use with oils, lotions, or other fluids.

An additional object of the present invention is to provide a massage implement that is easy to clean and sanitary.

An additional object of the present invention is to provide a massage implement that utilizes an object that can be safely and effectively heated.

An additional object of the present invention is to provide a massage implement that can utilize interchangeable golf balls that can be heated without interrupting the continued use of the massage implement.

An additional object of the present invention is to provide a massage implement that can serve functions beyond its utility as a massage implement.

An additional object of the present invention is to provide a massage implement that has broad cross-marketing appeal.

An additional object of the present invention is to provide a massage implement that is suited for promotional or marketing purposes.

An additional object of the present invention is to provide a massage implement that can be easily customized, imprinted, or branded.

An additional object of the present invention is to provide a massage implement that can accommodate commonly available vibrating, pulsating, or heating devices.

These and other objects, features, and advantages of the present invention will become more readily apparent from the attached drawings and from the detailed description of the preferred embodiments which follow.

### BRIEF DESCRIPTION OF THE DRAWINGS

The preferred embodiments of the invention will hereinafter be described in conjunction with the appended drawings, provided to illustrate and not to limit the invention, where like designations denote like elements, and in which:

FIG. 1 is a top view showing the general elements of a first exemplary embodiment of the massage implement of the present invention;

FIG. 2 is an end view of FIG. 1 showing the elements of a first exemplary embodiment of the massage implement of the present invention;

FIG. 3 is a side view of FIG. 1 showing the elements of a first exemplary embodiment of the massage implement of the present invention;

FIG. 4 is a bottom view of FIG. 1 showing the elements of a first exemplary embodiment of the massage implement of the present invention;

FIG. 5 is a side view of FIG. 1 showing the elements of a first exemplary embodiment of the massage implement of the present invention, illustrating the user's hand positioning as the massage implement is used.

FIG. 6 is a bottom view of FIG. 1 showing the elements of a first exemplary embodiment of the massage implement of the present invention, illustrating the user's hand positioning as the massage implement is used.

FIG. 7 is a top view showing the second exemplary embodiment of the massage implement of the present invention, illustrating cavities or voids in the massage implement.

FIG. 8 is a top view showing the third exemplary embodiment of the massage implement of the present invention, illustrating a channel that can be used to draw a straight and centered line on a golf ball.

FIG. 9 is an end view of FIG. 8 showing the elements of a third exemplary embodiment of the massage implement of the present invention.

FIG. 10 is a top view of a fourth exemplary embodiment of the massage implement of the present invention, illustrating a hole in the top so that the user can push the golf ball out of the massage implement with a finger.

FIG. 11 is an end view of FIG. 10 showing the elements of a fourth exemplary embodiment of the massage implement of the present invention.

FIG. 12 is a side view of FIG. 10 showing the elements of a fourth exemplary embodiment of the massage implement of the present invention, illustrating an extended lip which securely holds a golf ball within the massage implement.

FIG. 13 is a top view showing a fifth exemplary embodiment of the massage implement of the present invention, illustrating a hole in the end of the massage implement so that it can be attached to another object.

FIG. 14 is a side view of FIG. 13 showing a fifth exemplary embodiment of the massage implement of the present invention.

FIG. 15 is a top view showing a sixth exemplary embodiment of the massage implement of the present invention, illustrating several holes in the massage implement that can be used to hold golf tees.

FIG. 16 is a side view of FIG. 15 showing a sixth exemplary embodiment of the massage implement of the present invention.

FIG. 17 is a top view of a seventh exemplary embodiment of the massage implement of the present invention, illustrating a cavity in the massage implement to be used as a housing for a vibrating device.

FIG. 18 is a top view of FIG. 17 showing a seventh exemplary embodiment of the massage implement of the present invention, illustrating the insertion of a vibrating device into the massage implement.

FIG. 19 is a side view of FIG. 17 showing a seventh exemplary embodiment of the massage implement of the present invention.

FIG. 20 is a side view of FIG. 18 showing a seventh exemplary embodiment of the massage implement of the present invention.

Like reference numerals refer to like parts throughout the several views of the drawings. Use of express dimensions in any of the drawings serves only to illustrate some typical values for a typical user's hand, and does not limit the design from using different dimensions in specific implementation to accommodate different hand-sizes, ball-sizes, or other design purposes.

### MODES FOR CARRYING OUT THE INVENTION

Shown throughout the figures, the present invention is directed toward an inexpensive, convenient, sanitary, ergonomic, and versatile massage implement, made of a rigid or semi-rigid material that houses commonly available golf balls, or other objects of similar dimensions and properties.

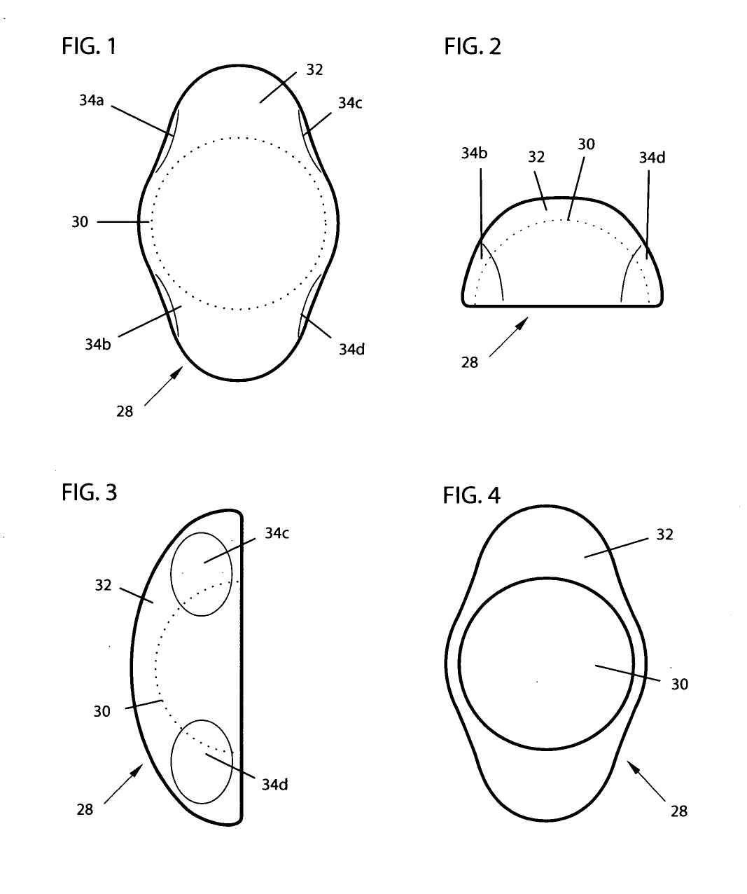

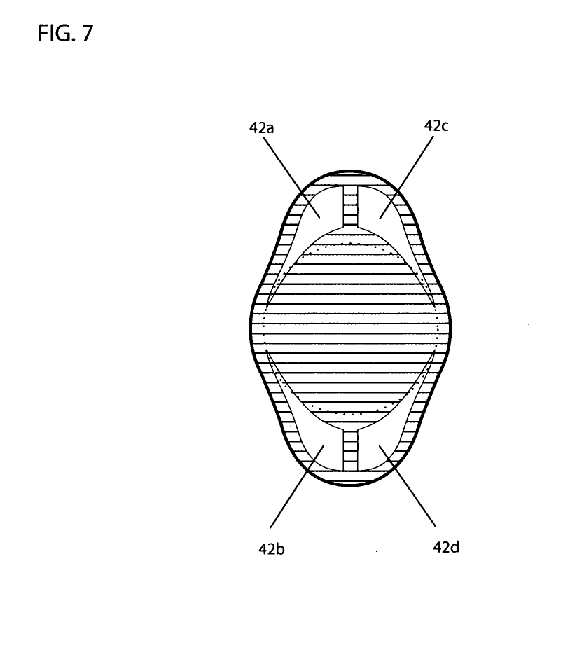

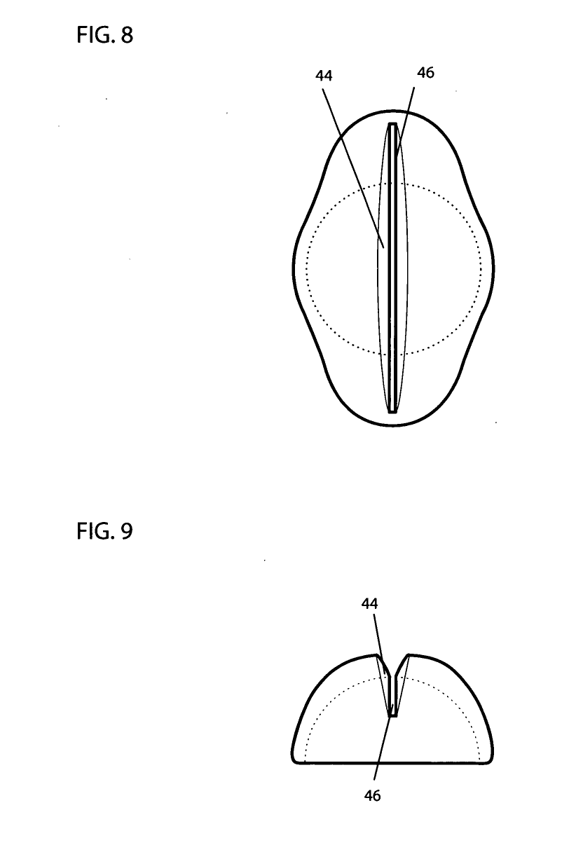

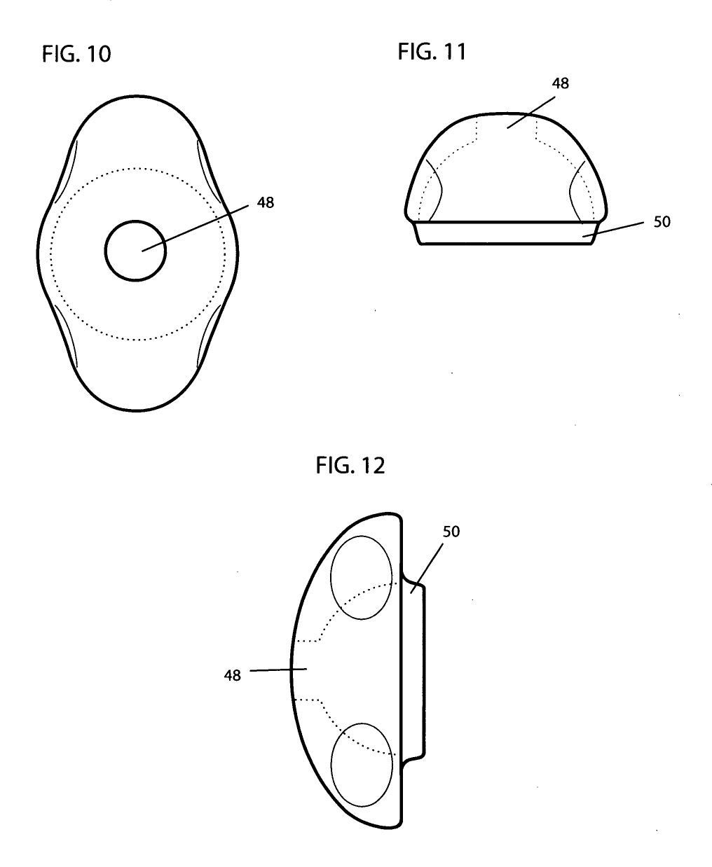

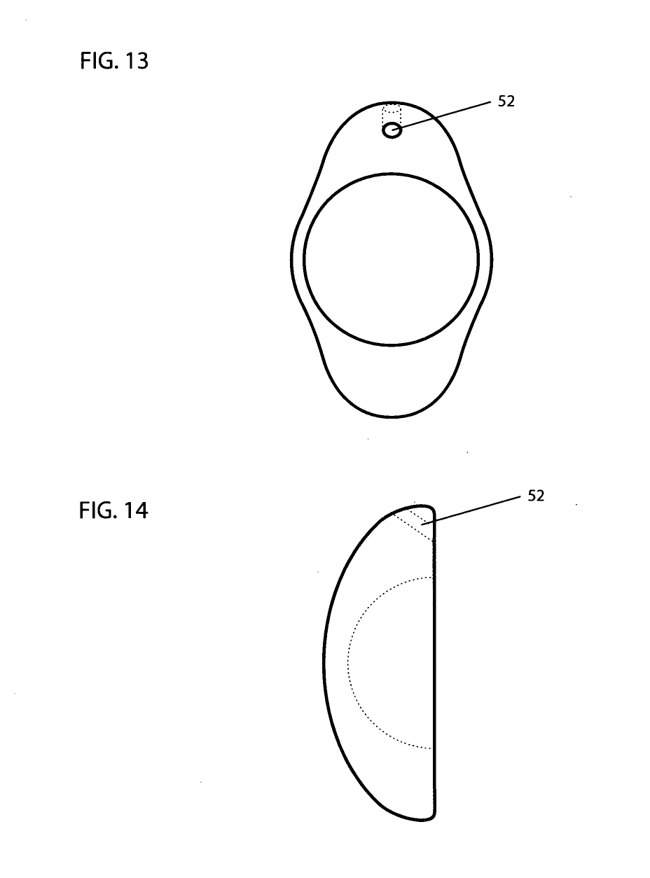

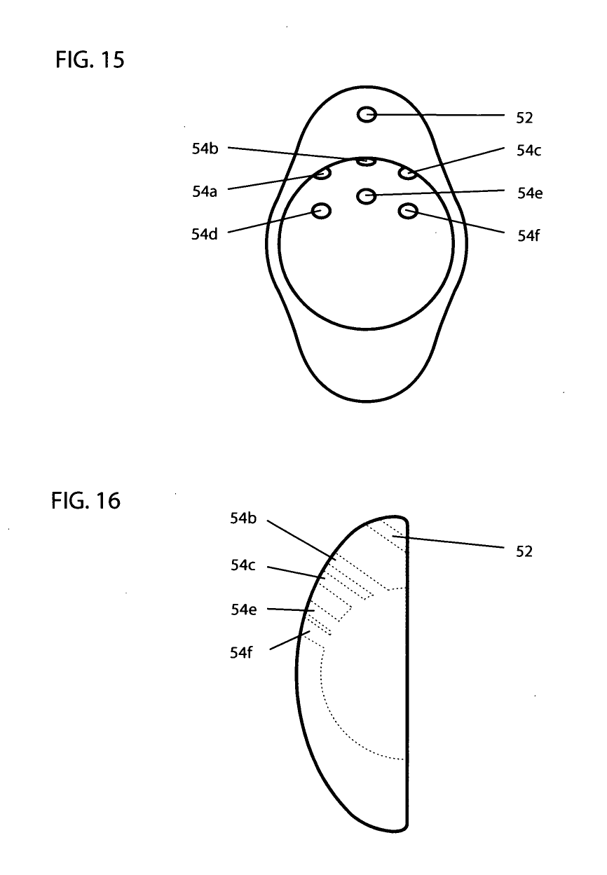

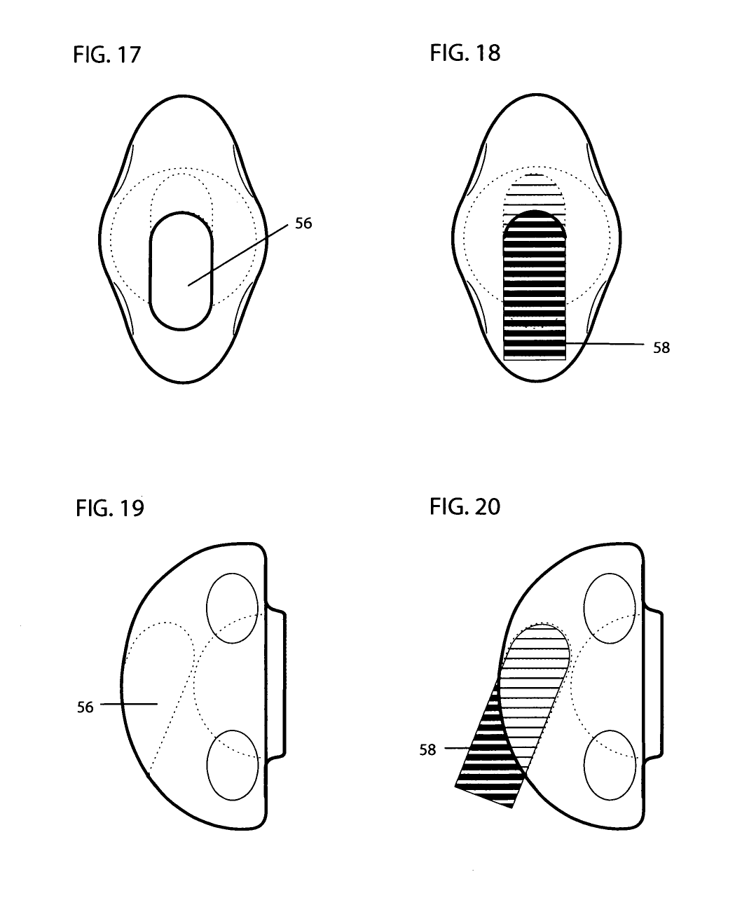

Seven exemplary embodiments of the massage implement are presented, but other similar embodiments are within the scope of the invention. The first exemplary embodiment of FIG. 1 to FIG. 6 presents the massage implement 28 generally, the second embodiment of FIG. 7 presents housing comprised of cavities 42a, 42b, 42c, and 42d in the material, the third embodiment of FIG. 8 to FIG. 9 presents a V-shaped channel 44 and opening 46 in the massage implement for lining a golf ball, the fourth embodiment of FIG. 10 to FIG. 12 presents a hole 48 and an extended lip 50 on cavity 30, the fifth embodiment of FIG. 13 to FIG. 14 presents a hole 52 for attachment to other objects, the sixth embodiment of FIG. 15 to FIG. 16 presents holes 54a, 54b, 54c, 54d, 54e, and 54f to be used as golf tee holders, and the seventh embodiment of FIG. 17 to FIG. 20 presents an additional cavity 56 and vibrating device 58.

Referring now to the top view of FIG. 1, a first exemplary embodiment of a massage implement, shown generally as reference number 28, is illustrated in accordance with a preferred embodiment of the present invention.

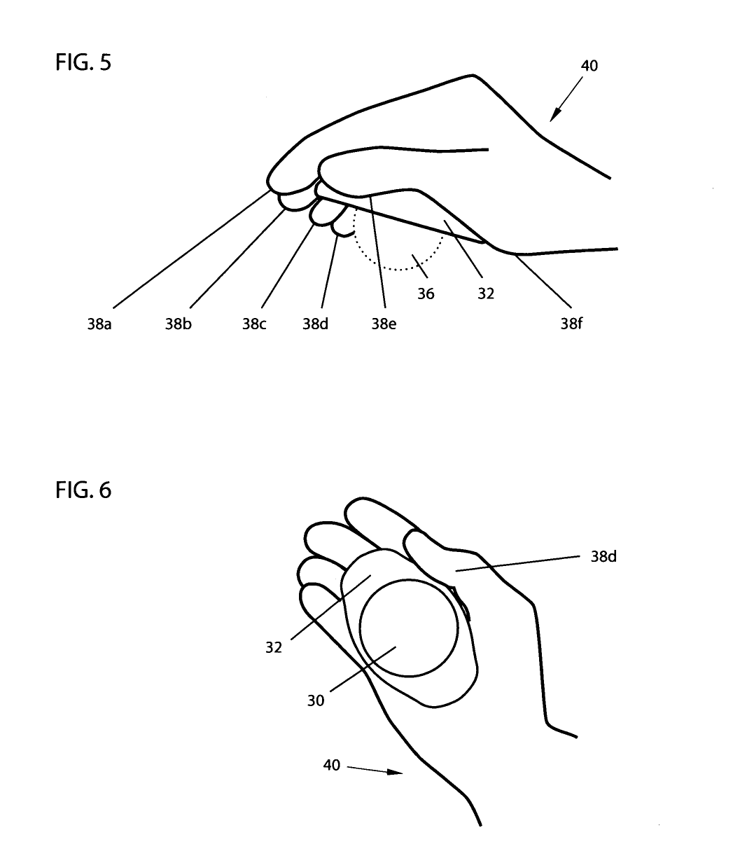

The massage implement 28 generally comprises a cavity 30, a housing 32, and finger grips 34a, 34b, 34c, and 34d. A standard golf ball 36 is inserted into cavity 30, then the user's hand 40 conforms to the contours of massage implement 28, and a secure and controlled grip is achieved by use of finger grips 34a, 34b, 34c, and 34d. Utilizing massage implement 28, as shown in FIG. 5, the user can perform a therapeutic massage and can maintain tactile contact with the object of the massage at points 38a, 38b, 38c, 38d, 38e, 38f, and 38g.

Massage implement 28 can be manufactured using common methods, such as injection molding, and inexpensive materials. This allows the user the added benefit of using the massage implement for inexpensive promotional or marketing purposes. Further, promotional items are common in many industries, and especially golf. Many of these items are in the form of “tournament handouts.” It is customary that the sponsors of a golf tournament include a gift bag comprised of various golf related items. Many of these items are inexpensive, golf related, and are mediums of advertising and promotion. The massage implement is an outstanding addition to such ends because of the common and persistent physical problems that plague many golfers.

Additionally, since the massage implement allows the user to use readily available golf balls that often are purchased in quantities, the balls themselves can be heated and interchanged within the massage implement without interrupting the massage itself, and without the use of expensive electrical or complex mechanical components.

FIG. 7 illustrates a preferred second embodiment of the massage implement 28 with cavities 42a, 42b, 42c, and 42d. These cavities reduce material costs, reduce the overall weight of the massage implement, add interesting architectural elements, and can also be used for an easy attachment to a placard for packaging or to other objects such as a golf bag. Easy attachment to a placard allows the seller or user to simply customize the placard for instructional or promotional purposes.

FIG. 8 and FIG. 9 illustrate a preferred third embodiment of massage implement 28 with a V-shaped channel 44 and a narrow opening 46. Golfers often mark a straight line on a golf ball so that directional orientation of the “putt” can be more easily achieved. For example, when a golfer addresses the golf ball on the golf putting surface, it is often difficult to see the “cup” and the golf ball at the same time while attempting to strike the ball. This difficulty is often overcome by marking a line on the golf ball, orienting the line to the intended target, then following that line while attempting to putt the ball. Channel 44 allows for the insertion of a variety of marking pens while opening 46 guides the tip of the marking pen along a straight path around the golf ball.

FIG. 10 to FIG. 12 illustrate a fourth preferred embodiment of massage implement 28 with an extended lip 50 and a hole 48. Lip 50 protrudes past the centerline of the golf ball and wraps around the ball, so as to hold it in place, while hole 48 allows the user to insert a finger to push the ball out. This allows the user to maintain placement of the ball within the device for more convenient use, and remove the ball for cleaning, interchanging heated balls, or storage of the massage implement.

FIG. 13 and FIG. 14 illustrate a fifth preferred embodiment of massage implement 28 with hole 52. Hole 52 provides more convenient attachment to other objects such as a golf bag. Golf bags often contain straps or rings for hanging various items from the golf bag such as towels or bag tags. This allows a golfer to readily access certain critical items without rummaging through the various pouches of a golf bag. Given the critical and versatile nature of the massage implement, this feature would allow the golf immediate and convenient access to the massage implement.

FIG. 15 and FIG. 16 illustrate a sixth preferred embodiment of massage implement 28 with holes 54a, 54b, 54c, 54d, 54e, and 54f. These holes allow the user to conveniently store the needed “golf tees” used during a round of golf. Golf tees are customarily used in conjunction with a club commonly referred to as a “Driver.” The driver has a larger club head which often necessitates a platform, or tee, to elevate the golf ball. Such tees are generally used several times during a round of golf. This embodiment makes access to the golf tees more convenient because the massage implement can be attached to the golf bag by hole 52 and hold several tees in a location proximate to the location of the golf clubs that are going to be used with such tees.

FIG. 17 to FIG. 20 illustrate a seventh preferred embodiment of massage implement 28 with cavity 56 and vibrating device 58. Many small and discrete vibrating devices are readily and commercially available at many retailers. Cavity 56 allows for convenient insertion of such vibrating devices so as to create an additional massage benefit during the course of a massage.

While seven embodiments are herein presented, their presentation is merely exemplary and not limiting. Other variations are within the scope of the invention, such as one or more of the following: variations in the rigid or semi-rigid material; variations in the manufacturing techniques of the massage implement; variations in the attachment mechanisms; variations in the size or shape of the massage implement; variations in the particular objects inserted into the massage implement; variations in the number of objects inserted; variations in the specific locations of the additional utilities within the massage implement; variations in the grip impressions; and variations in the particular combination of utilities herein described.

From the foregoing, it will be apparent that the massage implement provides an inexpensive, convenient, sanitary, ergonomic, and versatile massage implement while providing an opportune medium upon which advertising or promotional information can be distributed.

Since many modification, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

I claim:

1. An apparatus formed into a massage implement comprising a size and shape that accommodates the hand of a human user; made up of any of a variety of rigid or semi-rigid materials including plastic, silicone, Pyrex®, stone, ceramics, metals, wood or other suitable material; with dimensions and contours to facilitate the gripping of the user's fingers and thumb, and containing one or more cavities to accept golf balls or similar objects to facilitate massage purposes, including rolling ball type massages; and allowing the user to maintain tactile contact with the object of the massage.

2. An apparatus according to claim 1, wherein massage implement additionally comprises one or more penetrating holes that can provide attachment points for attachment to a golf bag or for other purposes.

3. An apparatus according to claim 1, wherein massage implement additionally comprises a channel penetrating from the user side into the cavity which accepts the golf ball, V-shaped with the narrow opening into the cavity, such that it can accommodate a writing instrument in a stable fashion to serve as a golf ball liner for drawing straight lines on golf balls.

4. An apparatus according to claim 2, wherein massage implement additionally comprises a channel penetrating from the user side into the cavity which accepts the golf ball, V-shaped with the narrow opening into the cavity, such that it can accommodate a writing instrument in a stable fashion to serve as a golf ball liner for drawing straight lines on golf balls.

5. An apparatus according to claim 1, wherein massage implement additionally comprises an opening penetrating from the user side into the cavity dimensioned to accommodate passage of a human finger to allow the user to push the golf ball out of the massage implement.

6. An apparatus according to claim 1, wherein massage implement additionally comprises an extended lip along the perimeter of the cavity for accepting golf balls such that the lip securely holds the golf ball within the massage implement.

7. An apparatus according to claim 5, wherein massage implement additionally comprises an extended lip along the perimeter of the cavity for accepting golf balls such that the lip securely holds the golf ball within the massage implement.

8. An apparatus according to claim 7, wherein massage implement additionally comprises that the extended lip along the perimeter of the cavity for accepting golf balls is formed from a flexible material such that the golf ball can be inserted or removed with application of finger pressure to briefly deform the lip sufficient for the golf ball to pass through.

9. An apparatus according to claim 1, wherein massage implement additionally comprises one or more additional cavities or voids that can serve to make the massage implement lighter, and serve to add additional architectural and design features.

10. An apparatus according to claim 1, wherein massage implement additionally comprises an additional cavity designed such that it can be used to hold available vibrating, pulsating, throbbing, or heating devices.

11. An apparatus according to claim 1, wherein massage implement additionally comprises features to provide protection to the hand of the user from fatigue and injury.

12. An apparatus according to claim 1, wherein massage implement additionally comprises multiple cavities for accepting golf balls, allowing the user to have two or more balls rolling on the massage recipient.

13. An apparatus according to claim 1, wherein massage implement additionally comprises that the single cavity for accepting golf balls is dimensioned to hold two golf balls within the same cavity, allowing the user to have two balls rolling on the massage recipient very close together.
